(19) United States
(12) Patent Application Publication
(10) Pub. No.: US 2008/0250698 A1
(43) Pub. Date: Oct. 16, 2008

(54) Three container candle assembly

(76) Inventor: Ajay Chadha, Tallahassee, FL (US)

Correspondence Address: Pennington, Moore, Wilkinson, Bell & Dunbar, P.A., Post Office Box 10095, Tallahassee, FL, 32302-2095, US

(21) Appl. No.: 11/809,654

(22) Filed: Jun. 1, 2007

Related U.S. Application Data
(62) Division of application No. 11/787,379, filed on Apr. 16, 2007.

(51) Int. Cl. C10L 7/00; A01N 25/08; F23D 3/16

(52) U.S. Cl. 44/265; 424/409; 431/291

(57) ABSTRACT

A dispensing formulation for a candle container assembly. The assembly includes an outer container, a medial container situated within and attached to the outer container, and a gel between the outer container and the medial container. The assembly further includes an inner container which contains a candle. The inner container may be removed and replaced when the candle is completely consumed.

### CROSS-REFERENCES TO RELATED APPLICATIONS

This is a divisional application of U.S. patent application Ser. No. ______ which names the same inventor.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of candles. More specifically, the invention comprises a three container candle assembly and is currently pending.

2. Description of the Related Art

Candles have been used for illumination and other purposes for many centuries. More recently, manufacturers have developed candle containers which utilize the heat generated by burning a centrally located candle to volatilize a chemical contained with a surrounding reservoir. The chemical is most often a fumigant or fragrance. U.S. Pat. No. 5,891,400 to Ansari et al. is representative of the prior art.

There are various disadvantages to the prior art candle containers. Conventionally, these candle containers are sold with a gel or wax-based candle integrated within an internal cavity of the container. The candle is usually consumed before all of the active chemical present in the surrounding reservoir has been volatilized. Because a wax or gel residue is left in the internal portion of the container after the candle is burned, the consumer generally must discard the container once the candle has been consumed. As such, it would be desirable to provide a candle container that allows for the easy replacement of the candle, so that the container may be reused.

Other disadvantages of prior art candle containers relate to the “gel” formulations used to dispense the active chemical. Many prior art gel compositions suffer from either being so “soft” that the gel suffers from creep and risks pouring out of the container during transport or so “stiff” that the transport of the active chemical out of the gel is negatively affected. Thus, it would be desirable to provide an active chemical dispensing composition which transports well and readily releases the active chemical when heated. It would also be desirable to have a dispensing formulation which is thermally reversible during the course of its use in order to dispense the active chemical without the loss of hydrocarbon oil.

### BRIEF SUMMARY OF THE INVENTION

The present invention comprises a candle container assembly. The assembly includes an outer container, a medial container situated within and attached to the outer container, and a substance between the outer container and the medial container. The assembly further includes an inner container which contains a heat source such as a candle. The inner container may be removed and replaced when the candle is completely consumed.

In the preferred embodiment, at least one of the medial container and the inner container is made of non-combustible, impact-resistant material such as polycarbonate. This prevents the container assembly from breaking during shipment or when replacing the inner container.

In the preferred embodiment the substance between the outer container and the medial container includes a gel with an additive such as a fragrance or an insect repellent. The gel preferably includes a mixture of Kraton and Septon triblock polymers.

### BRIEF DESCRIPTION OF THE SEVERAL VIEWS OF THE DRAWINGS

FIG. 1 is an exploded view, showing the candle container assembly.

FIG. 2 is a perspective view, showing the present invention in an assembled state.

FIG. 3 is a perspective view, showing the present invention with the inner container removed.

FIG. 4 is a top view, showing the present invention.

### REFERENCE NUMERALS IN THE DRAWINGS

| | | | |
|---|---|---|---|
| 10 | candle container assembly | 12 | outer container |
| 14 | medial container | 16 | inner container |
| 18 | base | 20 | base |
| 22 | fuel gel | 24 | wick |
| 26 | additive gel | | |

### DETAILED DESCRIPTION OF THE INVENTION

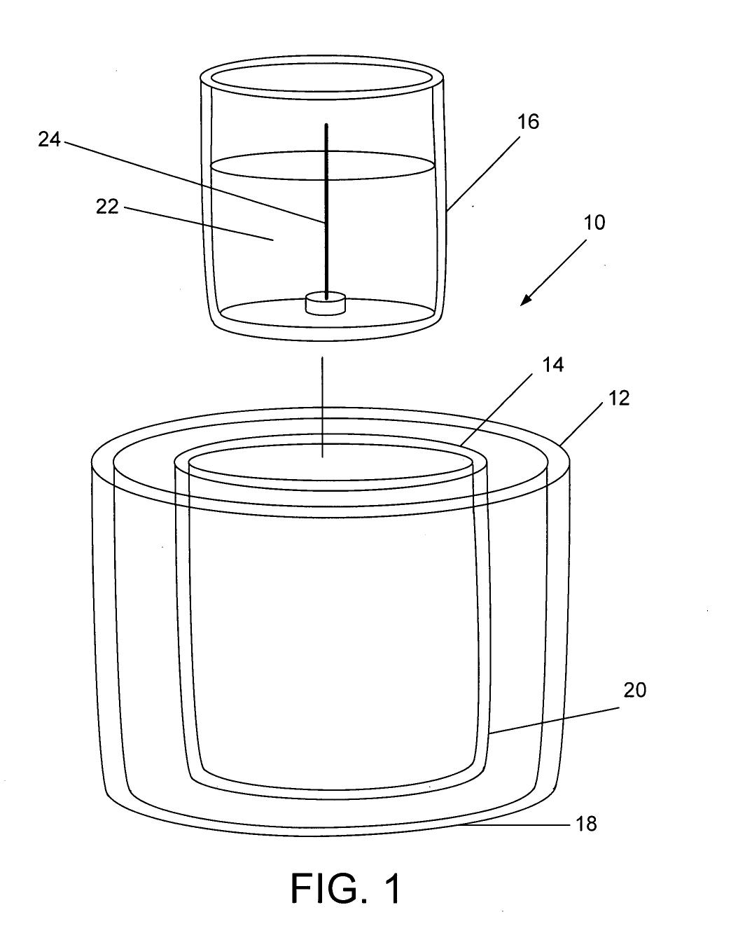

The present invention, candle container assembly 10, is illustrated in FIG. 1. Candle container assembly 10 includes outer container 12, medial container 14 situated within and attached to outer container 12, and removable inner container 16. Base 20 of medial container 14 and base 18 of outer container 12 may be attached together with an adhesive or the components may be thermally fused together or simply held in place with the assistance of a gel or wax. Inner container 16 includes fuel gel 22 and wick 24. Many different compositions for gel candles are known in the art. Inner container 16 could also contain a standard wax candle. Inner container 16 may be removed and replaced when the candle is completely consumed.

It is preferred that at least one of medial container 14 and inner container 16 be made of a non-flammable, impact-resistant material such as polycarbonate. Medial container 14 and/or inner container 16 may also be made of polyethylene terephthalate (PET), polyethylene terephthalic ester (PETE), high density polyethylene (HDPE), polypropylene, polystyrene, polytetrafluoroethylene, polyurethane, polyamide, polyester resin based materials and other suitable polymers. This prevents the container assembly from breaking from the glass-on-glass impact caused during shipment or when replacing inner container 16. It is also generally preferred for outer container 12, medial container 14, and inner container 16 to be transparent or translucent. Thus, in one embodiment outer container 12 and inner container 16 are made of glass while medial container 14 is made of clear polycarbonate.

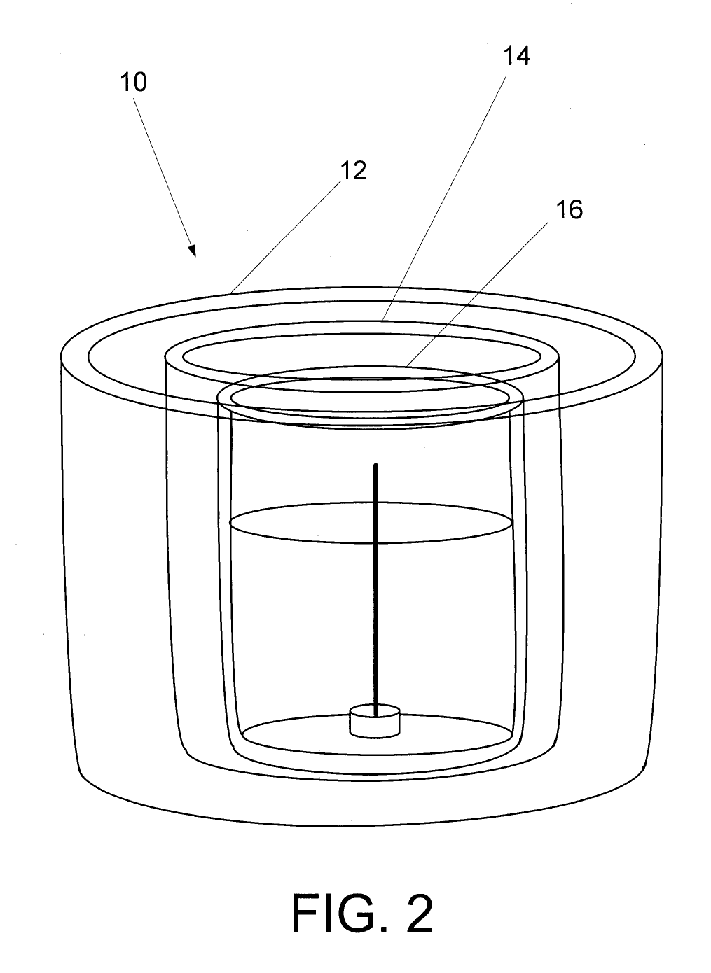

FIG. 2 shows inner container 16 situated within medial container 14. The reader will appreciate that the candle is contained within three distinct containers when candle container assembly 10 is assembled.

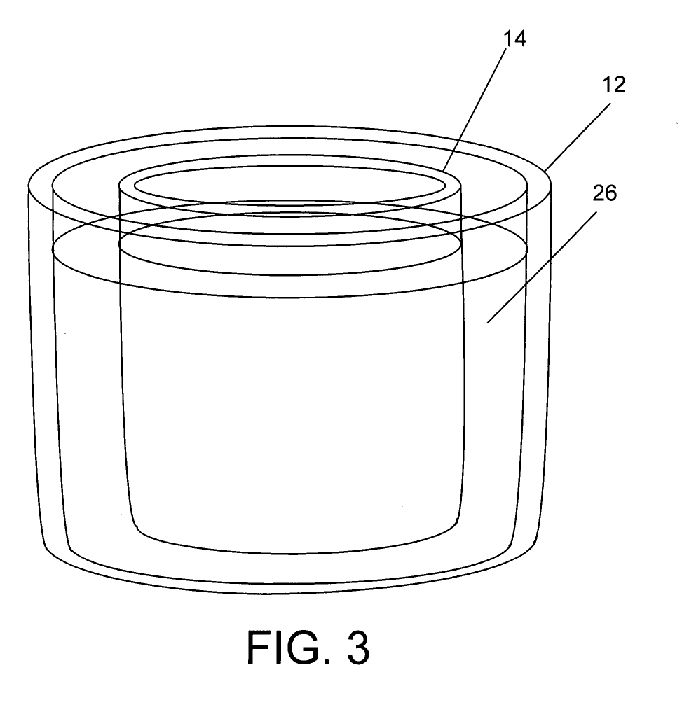

Turning now to FIG. 3 (which omits the inner container and candle), the reader will note that additive gel 26 has been added between outer container 12 and medial container 14. Additive gel 26 is preferably an oil-based gel and contains additives such as decorative objects, coloring agents, and/or a chemical additive which is to be volatilized. Many different chemical additives can be used in such a gel including well-known fragrances, insect repellents, or therapeutic oils (such as eucalyptus oil). The heat generated by burning the candle in inner container 16 vaporizes some of the chemical additive, and additive gel 26 releases these vapors to the environment over time.

Because candle container assembly 10 may be exposed to more candle-burning hours in comparison to prior art candle containers (because of the replaceability of inner container 16), a new formulation for additive gel 26 is needed to realize the advantages of such a reusable system. The new formulation is preferably capable of releasing additive vapors slowly and consistently over the length of time it takes to burn multiple candles is needed. Several embodiments of such a formulation will now be considered in greater detail.

The objectives of the present invention may be accomplished using an additive gel comprising di-block, tri-block, multi-block or radial copolymers or their mixtures. The styrenic di-block and tri-block copolymers are most compatible with hydrocarbon oils in varying proportions. Most preferred are the styrenic tri-block copolymers. Varying the concentration of styrenic tri-block copolymers can control the strength and the transport properties of the gels.

In the preferred embodiment, the additive gel comprises a tri-block polymer or a mixture of two tri-block polymers in hydrocarbon oil (mineral oil/white oil). The tri-block polymers Kraton G-1650 and Septon 4033 are most preferred polymers for the present invention. The hydrocarbon oil used in the present invention is not volatile between room temperature and 140° F., and more preferably the hydrocarbon oil is not volatile below 200° F.

Kraton G-1650, sold by Kraton Polymers LLC of Houston, Tex., is a polymer having a Styrene-Ethylene-Butylene-Styrene (SEBS) structure. The G group of Kraton rubbers are compatible with paraffinic and naphthionic oils. These triblock copolymers are reported as taking up more than 20 times their weight in oil and make a product which can vary in consistency from a “Jello” to a strong elastic rubbery material.

Septon 4033 is a thermoplastic rubber sold by Kuraray Co., Ltd. of Japan. The polymer has a Styrene-Isoprene-Butadiene-Styrene structure. The Septon 4033 rubber molecule is hydrogenated styrene block polymer with 2-methyl-1,3-butadiene and 1,3-butadiene. Septon 4033 has polystyrene end blocks and an elastomeric midblock.

For the purposes of the following examples, the reader should note that additive gel 26 generally includes a gel formulation and an additive. In the preferred embodiment, the gel formulation includes 6.4% weight Kraton G-1650, 1.6% weight Septon 4033, 0.01-0.05% weight butylated hydroxytoluene, with the balance comprising a hydrocarbon oil (such as mineral oil). The butylated hydroxytoluene acts as an antioxidant and prevents “yellowing” of the hydrocarbon oil which degrades the oils appearance, smell, and chemical properties. The gel composition can include up to 1% weight butylated hydroxytoluene.

It is preferred that the gel formulation contain Kraton G-1650 in a total gel weight range of 30.0%-0.5%. It is also preferred that the gel formulation contain Septon 4033 in a total gel weight range of 14.5%-0.5%. The combined weight percentage of Kraton G-1650 and Septon 4033 is preferably in the range of 30.0%-0.5%, with a more preferred range of 15%-6%, and the most preferred gel formulation being approximately 8% weight Kraton G-1650 and Septon 4033.

The mixture of Kraton G-1650 and Septon 4033 may be adjusted to achieve a product with the desired properties. More Kraton G-1650 can be added for superior cross-linking and reduced “creep.” Creep is a property of a gel which allows the gel to flow and potentially pour out of the container during transportation. More Septon 4033 can be added to soften the gel and improve the transport of the additive out of the gel. Increasing the concentration of Kraton G-1650 negatively affects the gel's ability to release the volatilized additive. Increasing the concentration of Septon 4033 makes the gel suffer from more “creep.” Thus, one faces trade-offs in adjusting the concentration of these components from the preferred ranges.

Once the gel is prepared, an additive is preferably added to the gel. As mentioned previously, the additive can include fragrances, insect repellents, therapeutic oils, coloring agents, UV stabilizers, and/or decorative materials (such as flower petals and other solid objects). If the additive is a chemical substrate such as a fragrance, insect repellent or therapeutic oil, it is preferred that the additive comprise 60%-0.05% of the total additive gel 26, with a more preferred range of 10% to 0.05%.

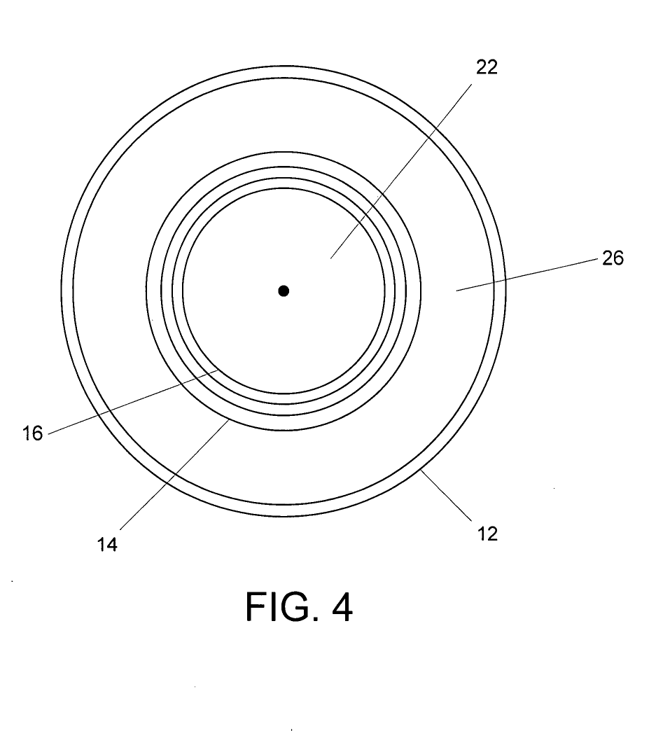

FIG. 4 is a top view showing the candle container assembly. Additive gel 26 is contained between outer container 12 and medial container 14. Candle 22 is contained within inner container 16. Thus, in order to heat gel 26, heat generated from burning candle 22 must pass through inner container 16, medial container 14 and the space between the two components.

The preceding description contains significant detail regarding the novel aspects of the present invention. It is should not be construed, however, as limiting the scope of the invention but rather as providing illustrations of the preferred embodiments of the invention. Thus, the scope of the invention should be fixed by the following claims, rather than by the examples given.

Having described my invention, I claim:

1. A dispensing formulation for a candle container assembly comprising:
a. a gel, including
i. a mixture of Septon 4033 and Kraton G-1650, said mixture having a weight percentage in the range of 0.5 to 30 percent of said gel;
ii. a hydrocarbon oil;
b. an additive mixed with said gel, said additive selected from a group consisting of:
i. a fragrance;
ii. an insect repellent;
iii. a coloring agent
iv. a therapeutic oil; and
v. a decorative solid object.

2. The dispensing formulation of claim 1, said mixture of Septon 4033 and Kraton G-1650 having a weight percentage in the range of 6 to 15 percent of said gel.

3. The dispensing formulation of claim 2, said mixture of Septon 4033 and Kraton G-1650 having a weight percentage of approximately 8 percent of said gel.

4. The dispensing formulation of claim 3, said gel comprising approximately 6.4% weight Kraton G-1650 and approximately 1.6% weight Septon 4033.

5. The dispensing formulation of claim 1, said gel comprising a greater weight percentage of Kraton G-1650 than Septon 4033.

6. The dispensing formulation of claim 1, wherein said hydrocarbon oil is nonvolatile below 140° F.

7. The dispensing formulation of claim 1, wherein said Kraton G-1650 comprises 0.5 to 14.5 percentage of the weight of said gel.

8. The dispensing formulation of claim 1, wherein said Septon 4033 comprises 0.5 to 14.5 percentage of the weight of said gel.

9. The dispensing formulation of claim 1, said additive comprising 0.05% to 60% of the weight of said dispensing formulation.

10. The dispensing formulation of claim 1, further comprising butylated hydroxytoluene, said butylated hydroxytoluene comprising 0.01 to 1% weight of said gel.

11. The dispensing formulation of claim 10, said butylated hydroxytoluene comprising 0.01 to 0.05% weight of said gel.

12. The dispensing formulation of claim 1, said dispensing formulation contained within a candle container assembly, said candle container assembly including:
a. an outer container;
b. a medial container situated within said outer container and attached to said outer container, said medial container comprising an inner surface and an outer surface, said outer surface facing said outer container;
c. an inner container situated within said medial container, said inner container having an outer surface and a hollow interior, said outer surface of said inner container facing said inner surface of said medial container; and
d. wherein said dispensing formulation is contained between said outer container and said outer surface of said medial container.

13. The dispensing formulation of claim 12, wherein said inner container is made of an impact-resistant, non-flammable material.

14. The dispensing formulation of claim 12, wherein said medial container is made of an impact-resistant, non-flammable material.

15. A dispensing formulation for a candle container assembly comprising:
a. a gel, including
i. a polymer, selected from a group consisting of a diblock polymer, a triblock polymer, a radial block copolymer and a multiblock copolymer;
ii. a hydrocarbon oil, said hydrocarbon oil not volatile below 140° F.;
b. an additive mixed with said gel, said additive selected from a group consisting of:
i. a fragrance;
ii. an insect repellent;
iii. a coloring agent;
iv. a therapeutic oil; and
v. a decorative solid object.

16. The dispensing formulation of claim 16, said gel including a mixture of Septon 4033 and Kraton G-1650 triblock copolymers having a weight percentage in the range of 6 to 15 percent of said gel.

17. The dispensing formulation of claim 16, said gel comprising a greater weight percentage of Kraton G-1650 than Septon 4033.

18. The dispensing formulation of claim 16, wherein said Kraton G-1650 comprises 0.5 to 14.5 percentage of the weight of said gel.

19. The dispensing formulation of claim 15, said additive comprising 0.05% to 10% of the total weight of said dispensing formulation.

20. The dispensing formulation of claim 15, said polymer being a styrenic triblock polymer.

21. The dispensing formulation of claim 20, said styrenic triblock polymer comprising Kraton G-1650.

22. A dispensing formulation for use with a heat source comprising:
a. a gel, including
i. a polymer, selected from a group consisting of a diblock polymer, a triblock polymer, a radial block copolymer and a multiblock copolymer;
ii. a hydrocarbon oil, said hydrocarbon oil not volatile below 140° F.;
b. an additive mixed with said gel, said additive volatile at a lower temperature than said gel;
c. wherein said dispensing formulation is configured to dispense said additive without the loss of said hydrocarbon oil when said dispensing formulation is exposed to said heat source.

23. The dispensing formulation of claim 22, said polymer being a styrenic triblock polymer.

24. The dispensing formulation of claim 23, said styrenic triblock polymer being Kraton G-1650.

25. The dispensing formulation of claim 22, said hydrocarbon oil not volatile below 200° F.

26. The dispensing formulation of claim 22, said polymer comprising 0.5-14.5% of said weight of said gel.

27. The dispensing formulation of claim 22, said gel comprising a mixture of Kraton G-1650 and Septon 4033.

28. The dispensing formulation of claim 27, said mixture of Kraton G-1650 and Septon 4033 comprising 0.5-30% of said gel.
